(19) United States
(12) Patent Application Publication
(10) Pub. No.: US 2011/0042559 A1
(43) Pub. Date: Feb. 24, 2011

(54) SUBSTANCE IDENTIFICATION USING A SERIES OF ION MOBILITY SPECTRA

(76) Inventor: Stefan Klepel, Taucha (DE)

Correspondence Address: Patrick J. O'Shea, Esq.;O'Shea Getz P.C., Suite 912, 1500 Main Street, Springfield, MA, 01115, US

(21) Appl. No.: 12/856,016

(22) Filed: Aug. 13, 2010

(30) Foreign Application Priority Data
Aug. 18, 2009 (DE) 10 2009 037 887.1

(51) Int. Cl. B01D 59/44

(52) U.S. Cl. 250/282

(57) ABSTRACT

A method for identifying an analyte includes introducing a transient cloud with an increasing and a decreasing analyte concentration into an ion mobility spectrometer, determining a series of analyte spectra, and identifying the analyte using mobility values and process kinetics from a formation of different types of analyte ions which is visible in a signal profile of the series of analyte spectra.

### PRIORITY INFORMATION

This patent application claims priority from German Patent Application No. 10 2009 037 887.1 filed on Aug. 18, 2009, which is hereby incorporated by reference.

### FIELD OF INVENTION

The invention relates to a method for identifying one or more substances using their mobility spectra at atmospheric pressure.

### BACKGROUND OF THE INVENTION

In recent decades, small stationary and mobile ion mobility spectrometers have been refined to detect traces of substances in ambient air. Examples of trace substances can include pollutants, such as poisons leaked during the manufacture and/or the use of chemicals, warfare agents, and vaporized clouds of unknown composition. Ion mobility spectrometers are widely used to, for example, monitor workplace environments in chemical plants and laboratories, continuously monitor filters, control drying processes, monitor waste air, et cetera. Ion mobility spectrometers can also be used by military or police to detect chemical warfare agents.

Detection of explosives or drugs in suitcases at airports can be particularly challenging. During such a typical detection, for example, a sample can be swabbed from an outside surface of a suitcase. The swabbed sample is vaporized at an inlet of an ion source of an ion mobility spectrometer. Measurements performed by the spectrometer, however, are frequently inaccurate due to interference from other substances in the suitcase such as essential oils from perfumes, skin powders, soaps or spices. Such essential oils can cause a false alarm because they generate ions of the same mobility as the target substances.

Alternatively, samples may be collected from the outside surface of the suitcase using a hot membrane interface probe. The substances that penetrate the hot membrane are guided to the ion mobility spectrometer in a hot gas-chromatographic capillary column. A short chromatogram of 30 to 100 seconds duration is produced that includes substance peaks of four to ten seconds in duration. The short chromatogram can improve the detectability by a partial separation of the substances. False alarms, however, still may occur.

Ions are usually continuously generated in an ion source of an ion mobility spectrometer. These ions are introduced, via an ion pulse, over a short period of time into a drift region of the spectrometer by a gating grid. An axially aligned electric field pulls the ions in the ion pulse through a drift gas in the drift region. The velocity of the ions are determined by their “mobility”, which in turn depends on their collision cross-section, their mass, their polarizability and their tendency to forth complex ions with molecules from the drift gas. Molecules of the unknown substance (i.e., an analyte) usually form several ion species such as monomer ions, dimer ions, attachment ions with H₂O or dissociative ions by splitting off H₂O or NO₂. The ions are formed in chemical ionization processes with reactant ions generated by the ion source. These reactant ions are also visible in the mobility spectrum.

Most ion species have a characteristic mobility and therefore travel through the drift region at its unique, characteristic speeds. At the end of the drift region, the incident ion current is measured at an ion detector, digitized and stored as a “mobility spectrum” in the form of a digitized sequence of measured values. Evaluating the mobility spectrum using the mobility signals of the individual ionic species provides the mobilities of the ions and therefore gives an indication as to the unknown substance.

Although ions with equal charge experience equal attractive force from the electric field, they typically have different drift velocities through the drift gas. The drift velocity depends on the mass, the molecular form and the collision cross-section of the ions. Lighter ions with masses approximately equal to the mass of the drift gas, for example, have drift velocities that depend substantially on their masses. Heavier drift ions having a mass greater than approximately one hundred atomic mass units, in contrast, have drift velocities that can be significantly influenced by their molecular form and collision cross-section. Specific arrangements of atoms in a molecule can change the collision cross-section and, thus, the drift velocity of an ion.

The drift region in small mobile spectrometers is typically about 10 centimeters long. The overall length including the ion source and the detector is about 15 centimeters. Such a small mobile spectrometer therefore can have a size roughly equal to that of a cigar box, which includes filters and pumps for the internal circulation of the drift gas (e.g., nitrogen). A stationary spectrometer designed for continuous operation, in contrast, has a size roughly equal to that of a desktop computer in order to include larger filters.

The sample ions (i.e., ions from the analytes) are usually formed by so-called “chemical ionization at atmospheric pressure” (APCI) in protonation or deprotonation reactions with the reactant ions. Monomeric, dimeric and, in rare cases at extremely high concentrations, trimeric pseudomolecular ions may be formed during the APCI. In addition, complexes of the ions with water, and collision gas molecules are generally present during the ion formation. “Pseudomolecular ions” may be defined as protonated or deprotonated analyte molecules. A pseudomolecular ion therefore has a mass that is increased or reduced, depending on its polarity, by one atomic mass unit compared to a normal molecular ion. Some substances can also dissociate when ionized and, therefore, produce water or nitrogen oxides. The relative intensity ratios of the individual ionic species depend on the concentration of the analyte molecules in the collision gas.

The grid is switched between the ion source and the drift region via an initiation pulse to measure the drift velocity of the different bunches of ions. As the ions drift, the diffusion of the ions in the forward and the aft direction generates a diffusion profile for each bunch of ions having the same mobility. The diffusion profile has a bell-shaped curve similar to a Gaussian distribution for each of the ion signals. The drift velocity and, thus, the mobility is determined from the measured drift time in the center of the bell-shaped curve and the known length of the drift region in the drift tube of the spectrometer.

The mobility of the ions is measured via the mobility constant K₀=v/E, where v designates the velocity and E the electric field. The mobility constant K₀ typically has units of cm²/(V s). The unknown substance can be identified from its main signal using the mobility constant, generally of the monomer ion. The identity can be confirmed by the mobility constant of a secondary signal, usually that of the dimer ion or a dissociation ion. Both positive and negative ions may be measured in mobility spectrometers by switching the drift voltage between each spectrum determination. For some substances where both positive and negative ions are formed, the mobility signals of the ions of the other polarity can be used to confirm the identity. Mobility constants for relevant signals of many pollutants are stored in libraries for use as references. Tolerances of at least one percent of the mobility value should be allowed for comparisons with mobility constants in libraries because the diffusion broadening of the mobility signals limit the accuracy of the mobility determination. This, in turn, can significantly limit the certainty of the identification.

The aforedescribed identification method can be successfully used where a limited number of types of pollutant occur and where there are minimal interference from other substances. The identification method therefore is well suited to, for example, workplace monitoring and analysis of military warfare agents. The identification method, however, may not be suitable for testing, for example, luggage with adherent traces of explosives or drugs because of the large number of substances, such as usually essential oils from spices or perfumes, which can interfere with the measurement.

The drift gas typically includes nitrogen or air with trace amounts of water vapor maintained at a constant concentration. The reactant ions for the chemical ionization of the analytes are usually generated by beta emitters such as ⁶³Ni. Corona discharges and other electron beam generators, and UV lamps or X-rays, however, may also be used as reactant ions. Some nitrogen molecules from air may be ionized and immediately react with water molecules to form complex ions such as (H₂O).OH₃⁺ or (H₂O).OH⁻. These complex ions may serve as reactant ions for the protonating or deprotonating ionization of the analytes. The complex water ions perform the actual chemical ionization of the analyte molecules.

Ions can typically pass through the bipolar grid, used as the grating grid, in approximately 100 to 300 microseconds. The spectrum is acquired in approximately 30 milliseconds. A typical spectral measurement process, with a repetition rate of around 30 spectra per second, has an ion utilization ratio of approximately one percent. The remaining 99 percent of the ions are discharged in the gating grid and are lost to the measurement process.

Increasing the ion utilization ratio from one percent to 50 percent, for example, would increase the signal-to-noise ratio by a factor of √50≈7. Increasing the signal-to-noise ratio, in turn, would increase the sensitivity of the measurement method by the same amount. German Application No. 10 2008 025 972.1 to U. Renner discloses one method for increasing the ion utilization ratio. This method includes analog modulation of the ion current from the ion source with a continuous modulation function with an instantaneous frequency that varies over a wide frequency range. The detector can then decode the ion current signal using a correlation with the modulation function.

A series of spectra are often acquired from single vaporization clouds introduced in the form of pulses in order to analyze substance mixtures. The series of spectra, in addition to thermal vaporization profiles or chromatographic effects in the swabbing paper or elsewhere, can cause slight shifts in the concentration profiles of the substances. The mobility spectra of the individual substances therefore can be mathematically separated and individually identified, assuming that the temporal profiles of the ion signals with different mobilities, but identical substances, closely follow the concentration profile with linear or square proportionality.

U.S. Pat. No. 7,541,577 to Davenport et al. discloses a method for identifying explosives that uses a so-called “peak-shifting” of the mobility signals in a series of mobility spectra; i.e., variabilities of the mobility of the ions formed. The variabilities are attributed to a nonlinear and concentration-dependent behavior in the presence of “taggants”, which are present in most explosives.

There is a need for an improved method of substance identification using series of ion mobility spectra.

### SUMMARY OF THE INVENTION

According to one aspect of the invention, a method is provided for identifying an analyte. The method includes introducing a transient cloud with an analyte concentration into an ion mobility spectrometer, determining a series of analyte spectra, and identifying the analyte using mobility values and process kinetics from a formation of different types of analyte ions which is visible in a signal profile of the series of analyte spectra.

Another aspect of the invention includes providing reference series of spectra of known substances, where each reference series of spectra introduces a transient cloud of an analyte with increasing and decreasing concentration into an ion source of the ion mobility spectrometer; determining a series of analyte spectra of the analyte; and comparing the series of analyte spectra with the series of reference spectra.

The identification of an analyte may utilize the different types of temporal variations of the ion signals of different mobility. The temporal variations typically mirror complex process kinetics involved in the formation of different types of analyte ions. The analyte is introduced into the ion mobility spectrometer in the form of a transient cloud with increasing and decreasing concentration; and a series of analyte spectra is acquired. The transient cloud can be, for example, (i) a desorption cloud from heated swabbing material, (ii) a head-space cloud introduced for a brief time, or (iii) a separated substance peak from a chromatographic process.

Temporal characteristics of the mobility signals may be used to identify the analyte when the process kinetics for the analyte ionization are known, or can be derived theoretically. This technique can also be used when the series of reference spectra are not available, for example, when the analytes stem from a large group of similar substances, and the series of reference spectra are not available for one or more of the substances.

In general, however, an analyte is identified by a similarity analysis between the series of analyte spectra and series of reference spectra of known substances from a library. The series of analyte spectra and the series of reference spectra may be compared by their mass spectra, infrared spectra, nuclear magnetic resonance spectra or any other type of spectra. A typical similarity analysis is performed by, for example, calculating similarity indices, and assuming a correct identification has been made when the similarity index (score) exceeds a minimum value and has a minimum difference to the spectrum with next closest similarity.

The similarity analysis may be performed between the temporal variation of the analyte ion signals and the reference ion signals for ions of the same mobility when, for example, there are corresponding ions of the same mobilities for the analyte ions and the reference ions. The series of reference spectra which have ion signals of the same mobility, therefore, should be selected before comparing the temporal characteristics. The similarity analysis may compare total curves of temporal variations. Alternately, the similarity analysis may use selected indicators such as the increase in the signals, position of the maxima, full width at half-maximum of the signal decrease, etc. These indicators can be stored together with the series of spectra, or stored instead of the series of spectra.

The similarity analysis may also be performed spectrum by spectrum from the series of the analyte spectra and from one series of the reference spectra in each case. Individual spectra of the series of analyte spectra or reference spectra can be omitted when such an omission increases similarities of the mobility spectra being compared. This adjusts the time axes with respect to each other.

Filters may be used such that not all series of reference spectra are included in the method. The series of analyte spectra and the series of reference spectra can be reduced to shortened series of spectra to accelerate the identification process. Such shortened series of spectra include those mobility spectra that each exhibit a predefined minimum difference from the preceding spectrum in terms of the pattern of the ion mobility signals. The calculation of similarity indices can be used for this reduction.

The reduced series of analyte or reference spectra can be combined into a single overall spectrum. The overall spectra can be used for the similarity analysis.

The complexity of the ion formation process in the ion source may be increased by introducing a doping agent. The doping agent is usually ionized in the ion source and contributes to the ionization of the analyte. The doping agent can be used, for example, to induce a dissociative charge transfer. The dissociative charge transfer can release reactant ions which, in turn, participate in the ionization of analyte molecules.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 graphically illustrates a series of mobility spectra of negative ions, from an explosive PETN (pentaerythritol tetranitrate), that were doped with a small quantity of dichloromethane during ionization;

FIG. 2 graphically illustrates a series of mobility spectra of negative ions, from an explosive nitroglycerine (NG), that were doped with a small quantity of dichloromethane during ionization;

FIG. 3 is a flow diagram of one embodiment of identifying an analyte; and

FIG. 4 is a schematic illustration of an ion mobility spectrometer.

### DETAILED DESCRIPTION OF THE INVENTION

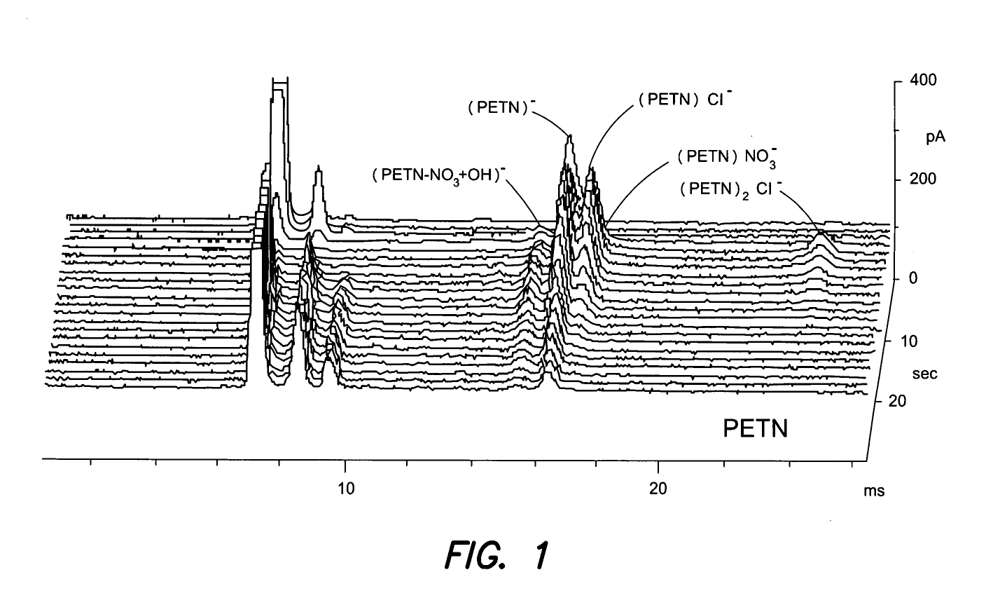

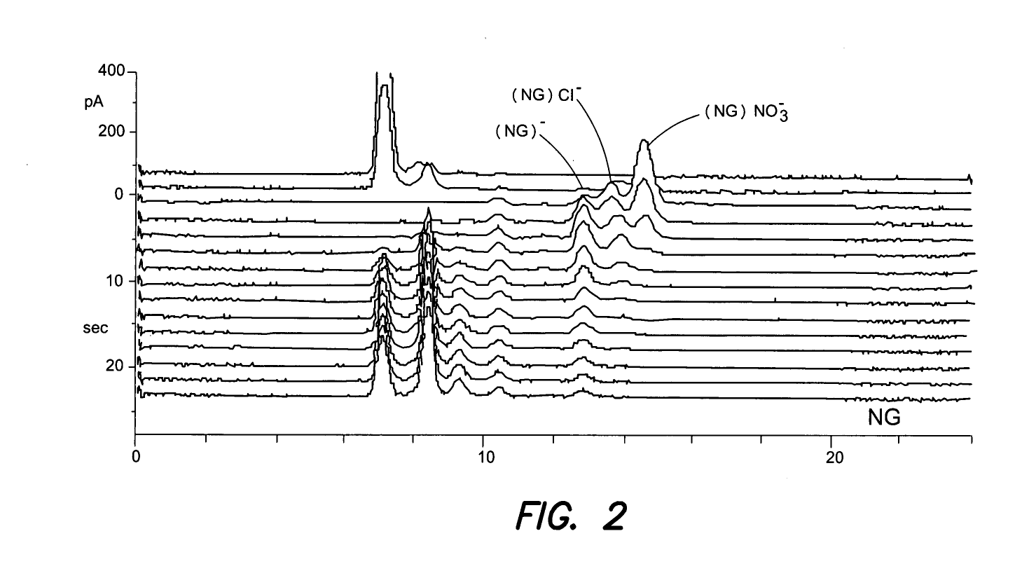

Some groups of analytes, such as explosives and certain drugs, have distinctive substance-specific process kinetics. When these groups of analytes are introduced into an ion mobility spectrometer as transient vaporization clouds, they typically form different types of ions at different times. The complexity of the process kinetics can be increased using a doping agent such as dichloromethane. The complex processes involved in the formation of the ions mean that the temporal variations of the mobility signals of the ions of an analyte no longer correlate with each other. Additional reactant ions such as NO₃⁻, for example, can be formed by dissociative charge transfer of negatively charged chlorine ions from explosives molecules, which usually include nitrogen oxides. The reactant ions can react with molecules of the analyte in a secondary reaction. The ions formed by the secondary reaction have a temporal variation curve that differs from that of the ions formed in the primary reaction. The temporal variations become visible in series of spectra which are determined from a transient vaporization cloud. Referring to FIGS. 1 and 2, signal intensities are graphically shown of a series of spectra for explosives PETN and NG that were doped with a small quantity of dichloromethane during ionization.

Prior art identification methods, as previously indicated, rely on an assumption that temporal variations of each ion signal of an analyte strongly correlate with one another and with the concentration profile. These methods, however, do not account for complex doped reactions that can create uncorrelated temporal variations in mobility signals of the analyte ions. In one aspect of the present invention a method for identifying an analyte utilizes the different temporal variations of the ion signals with different mobilities.

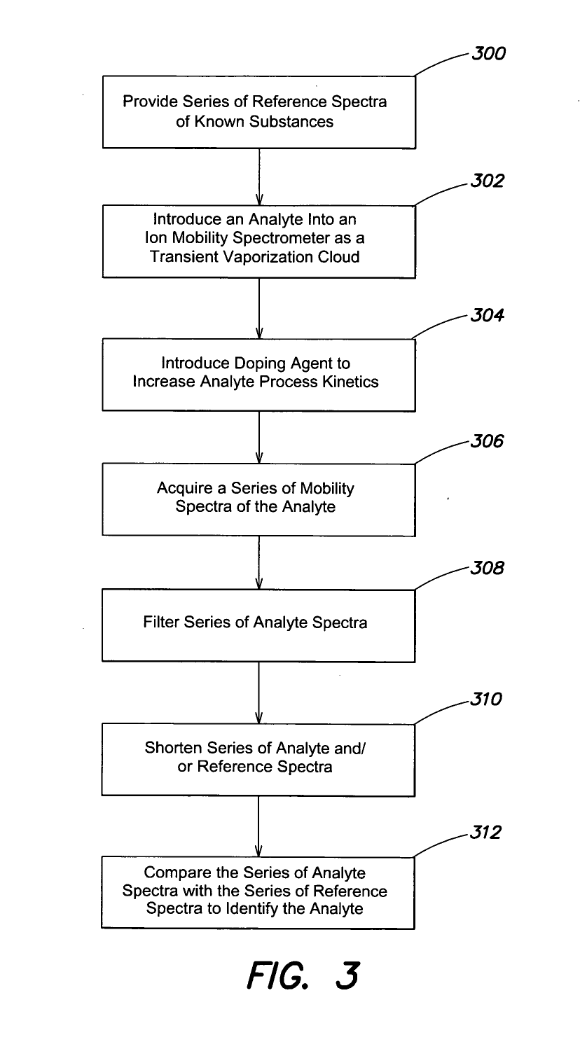

Referring to FIG. 3, an embodiment of a method for identifying an analyte, with an ion mobility spectrometer, includes a) providing series of reference spectra of known substances (see block 300); b) introducing a transient cloud of the analyte with increasing and decreasing concentration into the ion source of the ion mobility spectrometer (see block 302); c) acquiring a series of mobility spectra of the analyte (see block 306); and d) comparing the series of analyte spectra with the series of reference spectra using, for example, a similarity analysis (see block 312).

In Step a) and b) the transient clouds can be desorption clouds of substance samples on swabbing material. In Step d) the comparison can be carried out in the form of a similarity analysis.

The series of spectra can be limited to the mobility spectra of positive or negative ions; or they can contain mobility spectra of both positive and negative ions, which can be acquired alternately, for example.

Referring to block 302 in FIG. 3, a pure form of the analyte may be introduced into the ion mobility spectrometer in the form of a transient cloud with increasing and decreasing concentrations. A series of analyte spectra is determined at intervals, for example, of one half of a second. The transient cloud can comprise, for example, a desorption cloud that emanates from heated swabbing material. In another example, the transient cloud can comprise a cloud from a supernatant gas in a bottle. In this example, the cloud is introduced for a relatively short period during a so-called head-space analysis of a liquid. In still another example, the transient cloud can comprise a separated substance peak from a chromatographic process. The transient cloud may be introduced in a standardized form such that similar concentration profiles can be consistently determined. The transient cloud may be introduced for a duration of a few seconds; e.g., between approximately four and ten seconds. In some embodiments, the analyte is introduced into the ion source through a membrane. Permeation of the analyte through the membrane can help provide a consistent concentration profile for each individual analyte.

Referring to block 312 in FIG. 3, the unknown analyte can be identified utilizing both the occurrence of ions with characteristic mobility, and the complex process kinetics involved in the formation of the different types of analyte ions. The process kinetics for the ionization of an analyte may be known, or derived theoretically. The temporal variations of the mobility signals derived from this knowledge of the process kinetics can be used for the identification, even if no reference series of spectra are available. The reference series of spectra, for example, are often not available for analytes of substances from a large group of similar substances. Rules may be defined for the temporal variations of the mobility signals, e.g., for the sequence of the maxima for different types of ions, and used for the identification.

A similarity analysis may be performed to identify the unknown substance by comparing a measured series of analyte spectra to reference series of spectra of known substances. The reference series of spectra may be determined by introducing the known substances into a spectrometer as transient clouds at standardized acquisition intervals. The acquisition intervals for the mobility spectra of the series can be between approximately 0.1 and 2.0 seconds, depending on the ion mobility spectrometer and the operating method. The acquisition intervals, however, should be set at a standardized value such as, for example, approximately 0.5 seconds.

Various types of similarity analyses are known in the art for comparing measured and reference mass spectra, infrared spectra, nuclear magnetic resonance spectra, etc. Similarity analyses are usually used for all substance identifications which compare measured spectra with spectra from reference libraries, regardless of whether they are mass spectra, infrared spectra, nuclear magnetic resonance spectra or others. Many of these methods calculate similarity indices for performing the identification. An identification can be made, for example, when (i) a similarity index (e.g., a “score”) is greater than a minimum value, and (ii) there is a minimum difference between the similarity index of the next most similar spectrum. Many of the known similarity analyses can be used for identifying the unknown substance.

The similarity analysis may be performed, for example, between the temporal variations of the analyte ion signals and the temporal variations of reference ion signals for ions when the analyte ions and the reference ions have substantially equal mobilities. The reference series of spectra, therefore, should be selected before investigating the similarities of the temporal variations. In this manner, the similarity analysis may compare each of the temporal variations. The temporal variations may be extracted as a series of measured values of the respective ion signals from the series of spectra. Alternatively, stored indicators of the signal profile may be used for the similarity analysis. Examples of suitable stored indicators include indicators for the steepest increase in the signals, for the drift time of the ions of the maxima and possibly the minima, for the full width at half-maximum of the signal decrease, and for additional parameters.

The similarity analysis may also be performed, mobility spectrum by mobility spectrum, from the relevant series, i.e., orthogonally to the method just described, so to speak. The full series of measurements of the mobility spectra or the mobility values of the signal maxima extracted from the full series of measurements in the form of peak lists can be used during the similarity analysis. Since the concentration profiles of the transient clouds usually cannot be reproduced exactly, individual spectra of the series of analyte spectra or the reference series of spectra can be excluded to improve the similarity comparison of the mobility spectra. Excluding individual spectra may adjust the time axes (or concentration axis) of the series of spectra with respect to one another.

Referring to block 308 in FIG. 3, in some embodiments, filters may be used to exclude certain series of reference spectra from the similarity analysis.

Referring to block 310 in FIG. 3, the series of analyte spectra and each reference series of spectra may be shortened to accelerate the identification process. A shortened series includes, for example, only those mobility spectra whose spectral patterns each exhibit a predefined minimum difference from the preceding mobility spectrum of the shortened series. The shortened series may include four to ten mobility spectra, and preferably approximately seven mobility spectra. The similarity indices can be used to shorten each series where the acquisition of a spectrum uses, for example, a predetermined difference between the similarity index and the last acquired spectrum.

Each shortened series may include the same number of spectra of the same length. A shortened series of analyte or reference spectra can be combined into a single overall spectrum. The overall spectra, in turn, can be used for the similarity analysis.

The identification technique may be performed for analytes that belong to one or more selected substance classes; e.g., explosives or certain drugs. The analytes may be, for example, invisible deposits located on a surface of a suitcase.

Referring to block 304 in FIG. 3, the identification of the analytes from one of these selected substance classes can be improved by adding a suitable doping agent to the vaporization or desorption cloud that is introduced into the mobility spectrometer. The doping agent can form characteristic complex or dissociation ions with the ions from the aforesaid substance class. The doping agent therefore is selected for the substance class of the analytes. Dichloromethane is a particularly favorable doping agent for explosives. The mobilities and the variable abundance ratios of the complex and dissociation ions to the analyte ions may significantly contribute to the accuracy of the identification. Each reference series of spectra of the known substances are also acquired with the introduction of these doping agents.

False alarms can be reduced by obtaining a positive and satisfactory identification of the unknown substance when a clear mobility spectrum of a sample above the background noise occurs. Positive and satisfactory identifications can be performed when the library of the reference spectrum includes each substance that can be present as interferents during the analysis of a selected class of substances. For the detection of traces of explosives on suitcase surfaces interferents may include, for example, essential oils from perfumes, skin powders, soaps or spices.

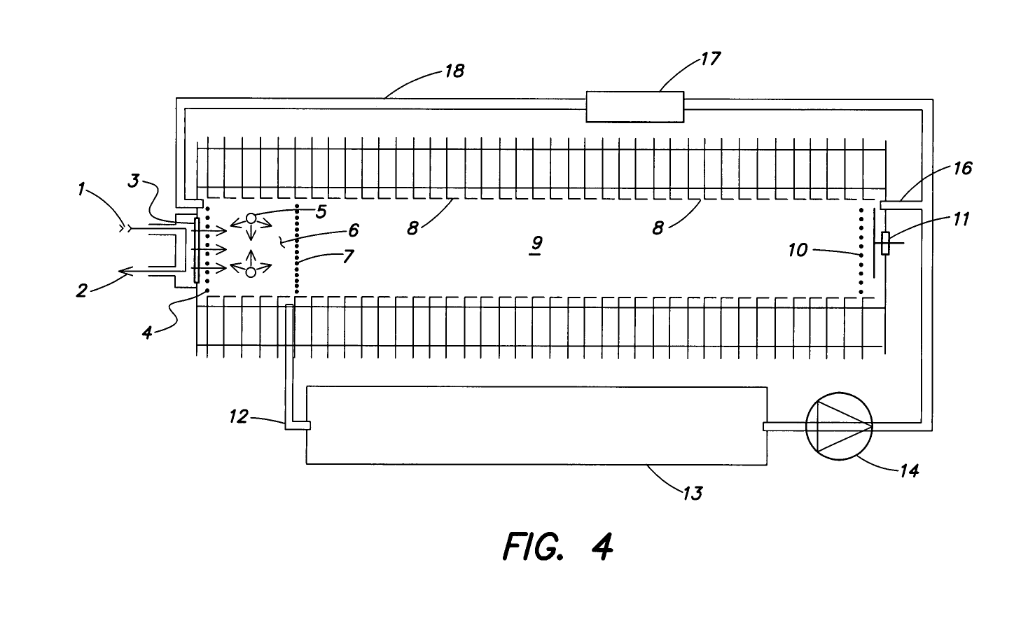

Referring to FIG. 4, an embodiment of an ion mobility spectrometer is shown for identifying an unknown substance using the aforedescribed method. A portion of the transient cloud of the analyte (e.g., an explosive from heated swabbing material) transported in an air stream 1, 2 permeates through a membrane 3 into an ion source 6. A beta emitter 5 initiates a reaction chain that ionizes the analyte. The ions are driven by a screen grid 4 and a plurality of parallel ring electrodes 8 toward a gating grid 7. The ions enter a drift region 9 through the gating grid 7. The drift region 9 is formed by the electrodes 8. Each electrode 8 is insulated from the adjacent electrodes 8. The drift region 9 uses a chain of resistors (not shown) to generate the axial electric field, via the electrodes 8, which draws the ions through the drift region according to their mobility. The ion current is measured by a detector 11 positioned behind a screen grid 10.

Nitrogen from the drift region 9 is directed through an input line 12 proximate the grating grid 7 to a filter 13. The nitrogen is cleaned (i.e., filtered) by the filter 13. The cleaned nitrogen is pumped, via a pump 14, into the drift region 9 proximate the detector 11 through an output line 16. The filter also can maintain a substantially constant water content.

A doping agent is added to a portion of the cleaned nitrogen at a doping station 17. The doped nitrogen is directed into the ion source 6 through an output line 18 in order to be used during the ionization of the unknown analyte.

The ion mobility spectrometer may determine the series of spectra for the unknown substance during various modes of operation. During a conventional pulsed operation, for example, ions may be introduced as pulses around 300 microseconds long through the gating grid 7 and into the drift region 9. The mobility spectra may then be determined directly at the detector 11. The acquisition of an individual spectrum takes around 30 milliseconds. Successive individual spectra are added together, measured value by measured value, in order to provide sum spectra with reduced noise content. The sum spectra form the actual spectra for the series. For example, approximately seventeen individual spectra are added together for series of spectra in which the individual spectra are approximately one half of a second apart. The quality of such summed spectra is satisfactory.

The inventive method may use a continuous modulation function with an instantaneous frequency varied over a relatively wide frequency range. The modulation is effected (or implemented) by the gating grid 7. The ion current signal produced at the detector 11 can be decoded by a correlation with the modulation function. The quality of the spectra (e.g., having a duration of one half of a second) can be increased over the conventional method. The sensitivity can be increased by a factor of approximately five. It is also possible to successfully obtain series of spectra whose individual spectra are determined at intervals as low as, for example, 0.2 seconds.

Although the present invention has been illustrated and described with respect to several preferred embodiments thereof, various changes, omissions and additions to the form and detail thereof, may be made therein, without departing from the spirit and scope of the invention.

What is claimed is:

1. A method for identifying an analyte, comprising:
introducing a transient cloud with an increasing and a decreasing analyte concentration into an ion mobility spectrometer;
acquiring a series of analyte spectra; and
identifying the analyte using mobility values and process kinetics from a formation of different types of analyte ions which is visible in a signal profile of the series of analyte spectra.

2. The method of claim 1, further comprising deriving theoretical temporal variations for the mobility values of analytes using the process kinetics, where the temporal variations are used for the identification.

3. The method of claim 1, where the identifying of the analyte comprises comparing the series of analyte spectra and reference series of spectra of known substances, where the reference series of spectra of each known substance has been acquired by introducing the known substances into an ion mobility spectrometer as transient clouds.

4. The method of claim 3, where the comparing of the series of analyte spectra and the reference series of spectra comprises performing similarity analyses.

5. The method of claim 4, where each similarity analysis is performed spectrum by spectrum.

6. The method of claim 5, where the similarity analysis is performed for the selected reference series of spectra.

7. The method of claim 5, where individual spectra of the series of analyte spectra or the reference series of spectra are omitted during the similarity analysis if this achieves better similarities between the mobility spectra which are compared in each case.

8. The method of claim 4, further comprising selecting the reference series of spectra such that the reference series of spectra and the series of analyte spectra have substantially equal mobilities, where the similarity analysis is performed between the temporal variations of the ions from the series of analyte spectra and the reference series of spectra.

9. The method of claim 8, further comprising filtering the series of analyte spectra and the reference series of spectra to remove non-characteristic mobility spectra, where characteristic mobility spectra have spectral patterns that each exhibit a predefined minimum difference from spectral patterns of the pre-filtered mobility spectrum.

10. The method of claim 9, where the filtered series of the analyte and/or reference spectra are each combined into an overall spectrum, and where the overall spectra are used for the similarity analysis.

11. The method of claim 1, where a doping agent is introduced into an ion source of the ion mobility spectrometer as the series of spectra are being determined.

12. The method of claim 11, where the analyte belongs to one of a plurality of selected classes of substances, and the doping agent is selected such that the process kinetics occur in the ion formation.

13. A method for identifying an analyte using an ion mobility spectrometer, comprising:
providing reference series of spectra of known substances, each derived from transient clouds with increasing and decreasing concentration;
introducing a transient cloud of the analyte with increasing and decreasing concentration into an ion source of the ion mobility spectrometer;
determining a series of analyte spectra of the analyte; and
comparing the series of analyte spectra with the series of reference spectra.

14. The method of claim 13, where the series of analyte spectra includes mobility spectra of positive and negative ions.

15. The method of claim 13, where the reference series of spectra includes interferents.

16. The method of claim 15, where the reference series of spectra further includes explosive substances, and where the interferents comprise one or more essential oils from perfumes, talcum powders, soaps or spices.

17. The method of claim 13, where the transient cloud comprises a desorption cloud.

18. The method of claim 17, further comprising providing the desorption cloud from a swab sample.
